(19) United States
(12) Patent Application Publication
(10) Pub. No.: US 2020/0134692 A1
(43) Pub. Date: Apr. 30, 2020

(54) E-COMMERCE RECOMMENDATIONS BASED ON SOCIAL EVENTS

(71) Applicant: International Business Machines Corporation, Armonk, NY (US)

(72) Inventors: Lisa Seacat DELUCA, Baltimore, MD (US); Kelley ANDERS, East New Market, MD (US); Jeremy A. GREENBERGER, San Jose, CA (US); Jeremy R. FOX, Georgetown, TX (US)

(21) Appl. No.: 16/172,673

(22) Filed: Oct. 26, 2018

(51) Int. Cl. G06Q 30/06; G06Q 50/00

(52) U.S. Cl. CPC G06Q 30/0631; G06Q 50/01

(57) ABSTRACT

A recommendations engine at a server determines that a user at a client device is accessing a website. The recommendations engine retrieves data of the user from one or more social media platforms and analyzes the data of the user to identify social events of the user. The recommendations engine generates a set of product recommendations for the user based at least on the social events of the user and causes an output of the set of product recommendations on the website. In one aspect of the present invention, as the user continues to navigate the website, the process is repeated. As new social events of the user are identified, the product recommendations for the user are modified. In this manner, real-time social events of the user can be used to dynamically modify the product recommendations presented to the user.

### BACKGROUND

Many retailers use social media platforms to show products on the social media pages as advertisements based on user activity on the retailer's site. For example, if a user views a white comforter on the retailer site, the user might see advertisements for the same comforter across the social media sites. However, when the user is visiting the retailer's website, information from the social media sites are not utilized in displaying recommendations.

### SUMMARY

Disclosed herein is a method for product recommendations on websites based on user social events, and a computer program product and system as specified in the independent claims. Embodiments of the present invention are given in the dependent claims. Embodiments of the present invention can be freely combined with each other if they are not mutually exclusive.

According to an embodiment of the present invention, a recommendations engine at a server determines that a user at a client device is accessing a website. The recommendations engine retrieves data of the user from one or more social media platforms and analyzes the data of the user to identify social events of the user. The recommendations engine generates a set of product recommendations for the user based at least on the social events of the user and causes an output of the set of product recommendations on the website.

### BRIEF DESCRIPTION OF THE DRAWINGS

FIG. 1 . . .

### DETAILED DESCRIPTION

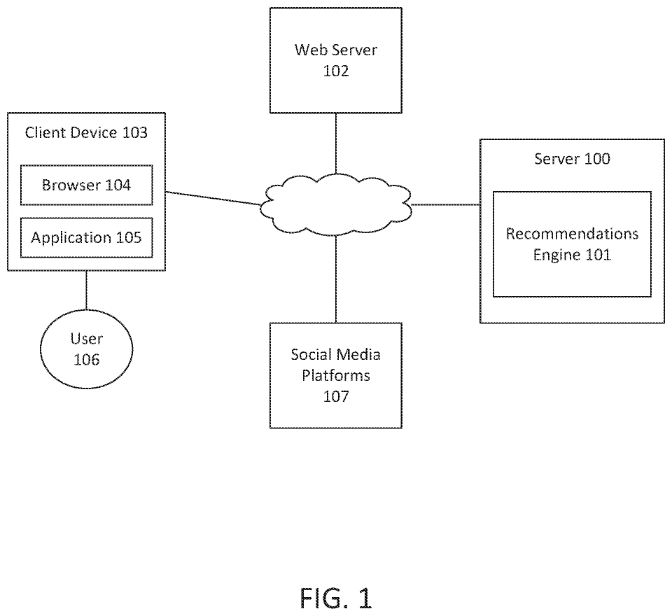

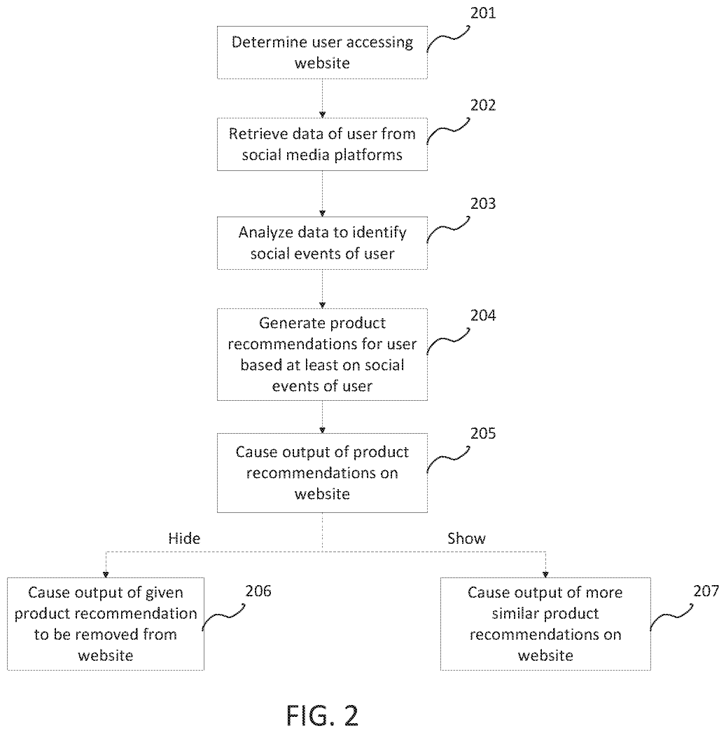

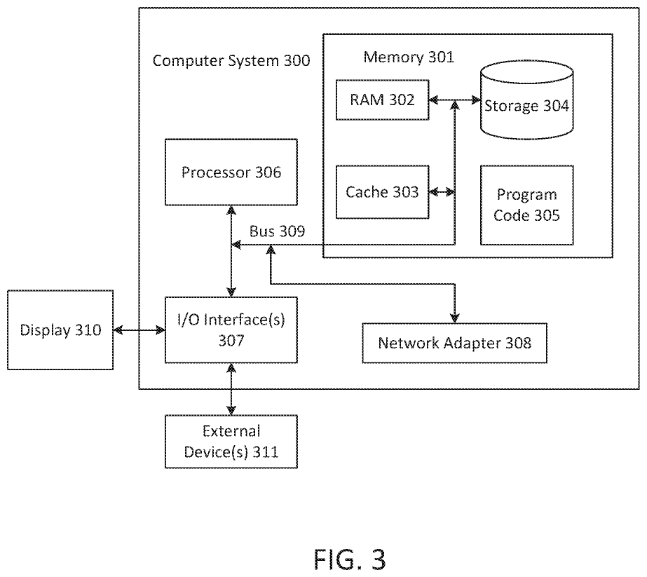

FIG. 1 illustrates a network environment for product recommendations on websites based on user social events, according to some embodiments. The network environment includes a server 100 with a recommendation engine 101. A web server 102 hosts an e-commerce website, accessible to a client device 103 via a browser 104 or an application 105. A user 106 of the client device 103 also interacts with one or more social media platforms 107. The recommendation engine 101 is configured to generate product recommendations for the website hosted by the web server 102 for display on the website. The recommendations engine 101 is further configured to retrieve data from the social media platforms 107 on social events of the user 106 or the user's network and to use the social events to generate product recommendations to be outputted on a website the user is accessing, as described further below.

FIG. 2 illustrates a method for product recommendations on websites based on user social events, according to some embodiments. The user 106 interacts with the social media platforms 107 in known ways. In some embodiments, the user 106 voluntarily opts in to allow the recommendations engine 101 access to their social media data. At some point, the recommendations engine 101 determines that the user 106, via the client device 103, is accessing a website that integrates an embodiment of the present invention (201). The recommendation engine 101 retrieves the data of the user from the social media platforms (202) and analyzes the data to identify social events of the user 106 (203). The social events may be from comments, formal changes in status, or direct messages to a user's contact. Examples social events may include, but are not limited to, any combination of the following: relationship change; job change; birth announcement; death announcement; new friendships or connections; wedding announcement; and anniversary announcement. The social events of the user 106 are fed to the recommendations engine 101. The recommendations engine 101 generates product recommendations for the user 106 based at least on the social events of the user 106 (204). According to some embodiments, a data file containing parameters describing behaviors of the user 106 (e.g. product views, location, previous purchases) are fed into the recommendations engine 101, from which a cross co-occurrence matrix may be generated and used in generating the product recommendations. Social events of the user 106 are included in this data file, and in this manner, product recommendations generated by the recommendations engine 101 are modified to take into consideration the social events of the user 106. Example product recommendations based on social events of the user 106 may include, for example, gift recommendations, wish-list recommendations, and event-specific recommendations (e.g. funeral flowers; birthday balloons, etc.). The product recommendations generated by the recommendations engine 101 are then sent to the web server 105, causing the product recommendations to be output on the website (205).

Optionally, the product recommendations output by the recommendations engine 101 includes an indication of the reasoning behind the product recommendation. Examples of the indication include: a photo of the social media connection associated with the product recommendation; a message indicating why the product recommendation is shown; and a percentage of other social media connections purchasing for a matching social event. The indication can then be displayed with the product recommendation on the website. Optionally, a feedback mechanism can be displayed to hide a product recommendation generated based on the social event (206) or to show more similar product recommendations generated based on the social event (207).

As the user 106 continues to navigate the website, blocks 202-205 are repeated. As new social events of the user 106 are identified, the product recommendations for the user 106, generated by the recommendations engine 101, can be modified. In this manner, real-time social events of the user 106 can be used to dynamically modify the product recommendations presented to the user 106.

Optionally, when a website has limited space on which to display the product recommendations, the recommendations engine 101 can additionally determine the most popular social events of the user 106 by analyzing the social interactions of the social events. For example, the popularity of the social events can be based on the number of “likes” or “shares”. The recommendations engine 101 generates product recommendations based on the most popular social events and causes the output of these product recommendations.

For example, assume that the recommendations engine 101 determines that Bob is browsing a retail website. Assume also that Bob recently had a fight with his girlfriend and asked for advice from a friend on a social media platform. The recommendations engine 101 retrieves the request for advice as part of the social media data for Bob, and in analyzing the data, identifies the fight with his girlfriend as a social event for Bob. Based at least on this social event, the recommendations engine 101 generates a product recommendation for “I'm Sorry” products and includes with the product recommendation an indication that the recommendation was based on his fight which his girlfriend (e.g. “Because you fought with Sara . . . ”), making the product recommendations more meaningful for Bob.

For another example, assume that the recommendations engine 101 determines that Bob visits a website for flowers. Assume also that Bob's social media feed includes a post by a friend that her mother recently died. The recommendations engine 101 retrieves data concerning this post as part of the social media data for Bob, as well as the zip code of the friend. In analyzing the data, the recommendations engine 101 identifies the death of his friend's mother as a social event for Bob. Based at least on this social event, the recommendations engine 101 generates a product recommendation for funeral flower arrangements and includes a message to be displayed on the website, such as, “I see your friend's mom died. Will this be a gift for her?” Assume that the recommendations engine 101 further provides a mechanism through which Bob can confirm that the gift would be for the passing of the friend's mother. Upon receiving the confirmation from Bob, the recommendations engine 101 filters the product recommendations by the zip code of the friend to display the recommendations most relevant to Bob for this particular social event.

FIG. 3 illustrates a computer system according to embodiments of the present invention. One or more of the computer system 300 can be used to implement the server 100 according to some embodiments. The computer system 300 is operationally coupled to a processor or processing units 306, a memory 301, and a bus 309 that couples various system components, including the memory 301 to the processor 306. The bus 309 represents one or more of any of several types of bus structure, including a memory bus or memory controller, a peripheral bus, an accelerated graphics port, and a processor or local bus using any of a variety of bus architectures. The memory 301 may include computer readable media in the form of volatile memory, such as random access memory (RAM) 302 or cache memory 303, or non-volatile storage media 304. The memory 301 may include at least one program product having a set of at least one program code module 305 that are configured to carry out the functions of embodiment of the present invention when executed by the processor 306. The computer system 300 may also communicate with one or more external devices 311, such as a display 310, via I/O interfaces 307. The computer system 300 may communicate with one or more networks via network adapter 308.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method for product recommendations on websites based on user social events, comprising:
determining, by a recommendations engine at a server, that a user at a client device is accessing a website;
retrieving, by the recommendations engine, data of the user from one or more social media platforms;
analyzing, by the recommendations engine, the data of the user to identify social events of the user;
generating, by the recommendations engine, a set of product recommendations for the user based at least on the social events of the user; and
causing, by the recommendations engine, an output of the set of product recommendations on the website.

2. The method of claim 1, wherein a given product recommendation of the set of product recommendations further comprise an indication of a reasoning behind the given product recommendation based on a given social event of the user, wherein the recommendations engine further causes an output of the indication with the given product recommendation on the website.

3. The method of claim 2, wherein the recommendations engine further causes a feedback mechanism to be output on the website to hide the given product recommendation or to show more product recommendations matching the given social event of the user.

4. The method of claim 1, wherein the generating of the set of product recommendations comprises:
determining, by the recommendations engine, one or more most popular social events of the user; and
generating, by the recommendations engine, the set of product recommendations for the user based at least on the one or more most popular social events of the user.

5. The method of claim 1, wherein the generating of the set of product recommendations comprise:
generating a cross co-occurrence matrix using a data file containing parameters describing behavior of the user, the data file comprising the social events of the user; and
generating the set of product recommendations using the cross co-occurrence matrix.

6. A computer program product for product recommendations on websites based on user social events, the computer program product comprising a computer readable storage medium having program instructions embodied therewith, the program instructions executable by a processor to cause the processor to:
determine that a user at a client device is accessing a website;
retrieve data of the user from one or more social media platforms;
analyze the data of the user to identify social events of the user;
generate a set of product recommendations for the user based at least on the social events of the user; and
cause an output of the set of product recommendations on the website.

7. The computer program product of claim 6, wherein a given product recommendation of the set of product recommendations further comprise an indication of a reasoning behind the given product recommendation based on a given social event of the user, wherein the processor further causes an output of the indication with the given product recommendation on the website.

8. The computer program product of claim 7, wherein the processor further causes a feedback mechanism to be output on the website to hide the given product recommendation or to show more product recommendations matching the given social event of the user.

9. The computer program product of claim 6, wherein the generating of the set of product recommendations comprises:
determine one or more most popular social events of the user; and
generate the set of product recommendations for the user based at least on the one or more most popular social events of the user.

10. The computer program product of claim 6, wherein the generating of the set of product recommendations comprise:
generate a cross co-occurrence matrix using a data file containing parameters describing behavior of the user, the data file comprising the social events of the user; and
generate the set of product recommendations using the cross co-occurrence matrix.

11. A system comprising:
a processor; and
a computer readable storage medium having program instructions embodied therewith, the program instructions executable by the processor to cause the processor to:
determine that a user at a client device is accessing a website;
retrieve data of the user from one or more social media platforms;
analyze the data of the user to identify social events of the user;
generate a set of product recommendations for the user based at least on the social events of the user; and
cause an output of the set of product recommendations on the website.

12. The system of claim 11, wherein a given product recommendation of the set of product recommendations further comprise an indication of a reasoning behind the given product recommendation based on a given social event of the user, wherein the processor further causes an output of the indication with the given product recommendation on the website.

13. The system of claim 12, wherein the processor further causes a feedback mechanism to be output on the website to hide the given product recommendation or to show more product recommendations matching the given social event of the user.

14. The system of claim 11, wherein the generating of the set of product recommendations comprises:
determine one or more most popular social events of the user; and
generate the set of product recommendations for the user based at least on the one or more most popular social events of the user.

15. The system of claim 11, wherein the generating of the set of product recommendations comprise:
generate a cross co-occurrence matrix using a data file containing parameters describing behavior of the user, the data file comprising the social events of the user; and
generate the set of product recommendations using the cross co-occurrence matrix.
